(19) United States
(12) Patent Application Publication
(10) Pub. No.: US 2018/0022150 A1
(43) Pub. Date: Jan. 25, 2018

(54) WATER DIVERTER FOR A WHEEL HAVING A BEAD RING

(71) Applicant: Wheel Pros, LLC, Greenwood Village, CO (US)

(72) Inventor: Peter Tran, Irvine, CA (US)

(73) Assignee: Wheel Pros, LLC, Greenwood Village, CO (US)

(21) Appl. No.: 15/214,350

(22) Filed: Jul. 19, 2016

(51) Int. Cl. B60B 15/00

(52) U.S. Cl. CPC B60B 15/00

(57) ABSTRACT

Disclosed is a device for diverting water from within a channel of a wheel having a bead ring. The device comprises an adapter having a cylindrical depression, the cylindrical depression comprising a socket for securing the device to a wheel. The device further comprises a diverter arm coupled to the adapter and extending away from the adapter, the diverter arm extending laterally outward and comprising one or more ramps. The adapter may be bolted into a bead ring of the automobile wheel. The one or more ramps may be disposed within a channel of the wheel between the bead ring and the face of the wheel. A side of the diverter arm facing the channel may be curved to allow the ends of the one or more ramps to lie flush against the channel. The one or more ramps may be inclined away from the face of the wheel.

### FIELD OF TECHNOLOGY

This disclosure relates generally to aftermarket vehicle parts and, more particularly, to an apparatus for diverting water from aftermarket wheels having simulated bead rings.

### BACKGROUND

In some aftermarket wheels with simulated bead rings, a channel is formed between the ring and the face of the wheel. However, water is collected in this channel when the vehicle is operated in rainy conditions. Accumulation of water or other fluid in the channel can lead to an asymmetry of mass throughout the wheel and/or across the vehicle. This asymmetry can cause ride disturbances, usually in the form of vertical and lateral vibrations. This can result in wobbling of the steering wheel or of the entire vehicle. At high speeds, the vehicle's suspension may be unable to account for such vibrations when the wheel's rotating frequency is equal to the suspension's resonant frequency, at which point the vibrations may propagate throughout the entire suspension of the vehicle. If such propagation occurs when driving the vehicle on a highway in rainy conditions, a vehicle with aftermarket wheels with simulated bead rings may experience severe ride disturbances, which if unheeded by the driver, may result in a fatal accident due to loss of control of the vehicle.

### SUMMARY

Disclosed is an apparatus for diverting water from aftermarket wheels with simulated bead rings.

In one aspect, a device for attachment to an automobile wheel comprises an adapter having a cylindrical depression, the cylindrical depression comprising a socket for securing the device to an automobile wheel. The device further comprises a diverter arm coupled to the adapter and extending away from the adapter, the diverter arm extending laterally outward and comprising one or more ramps.

In another aspect, a device for attachment to an automobile wheel comprises an adapter having a cylindrical depression, the cylindrical depression comprising a socket for securing the device to a bead ring of an automobile wheel. The device further comprises a diverter arm orthogonally positioned to the adapter and coupled to the adapter, the diverter arm comprising one or more ramps, the ends of the one or more ramps configured to lie flush against a channel between the bead ring and the face of the automobile wheel.

In yet another aspect, a method of diverting water from an automobile wheel using a water diverter device comprises securing an adapter of a water diverter device to a bead ring of an automobile wheel, the adapter having a cylindrical depression, the cylindrical depression having a socket at its terminus. The water diverter device additionally comprises a diverter arm coupled to the adapter and extending away from the adapter, the diverter arm extending laterally outward comprising one or more ramps.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a sectional view and a face view of a wheel having a simulated bead ring, according to one or more embodiments.

FIG. 2A is a perspective view of a water diverter, according to one or more embodiments.

FIG. 2B is a side view and a front view of the water diverter, according to one or more embodiments.

FIG. 3 is a view of the water diverter of FIGS. 2A-B fastened to the simulated bead ring of the wheel of FIG. 1, according to one or more embodiments.

FIG. 4 is a sectional view of the wheel of FIG. 1 showing positioning of the water diverter of FIGS. 2A-B within the wheel, according to one or more embodiments.

Other features of the present embodiments will be apparent from the accompanying drawings and from the detailed description that follows.

### DETAILED DESCRIPTION

Example embodiments, as described below, may be used to provide an apparatus for diverting water from wheels with simulated bead rings.

A wheel with a simulated bead ring may comprise a channel between the face of the wheel and the simulated bead ring of the wheel. This channel may be made during undercut machining. While driven in rainy weather, the recess may accumulate water, which may cause imbalance throughout the wheel.

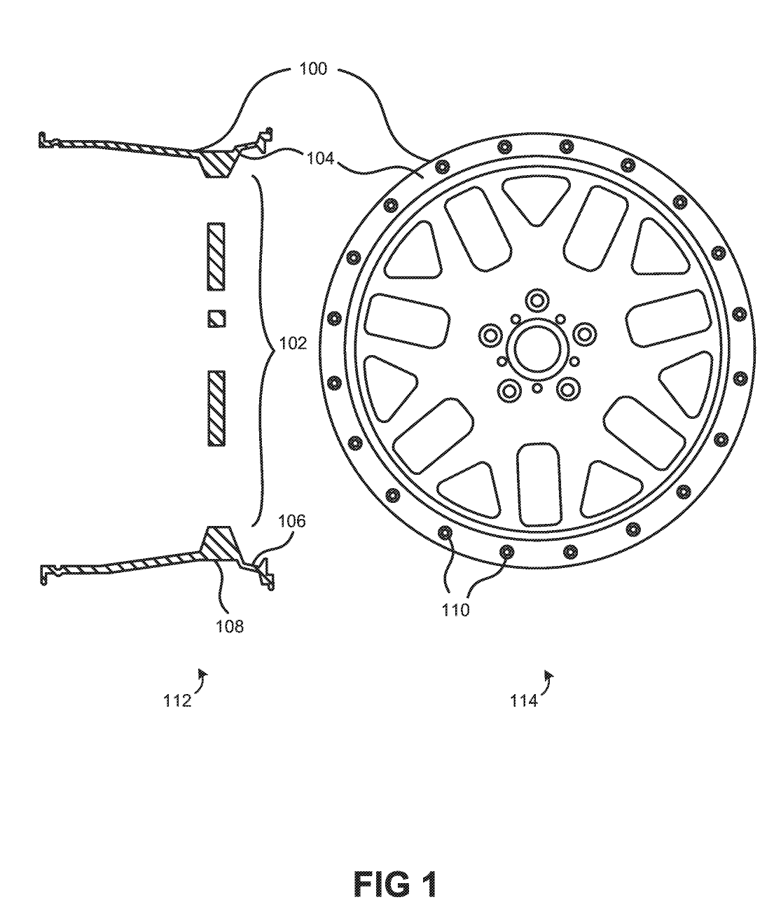

Reference is now made to FIG. 1, which illustrates a sectional view 112 and a face view 114 of a wheel 100, according to one or more embodiments. The wheel 100 may comprise a face 102, a bead ring 104, a channel 106, and a drop center 108. The bead ring 104 may be a simulated bead ring, in that the simulated bead ring is not used to fix a tire to the wheel but is desired for its appearance rather than utility. It would be appreciated that a person of skill in the art (“POSITA”) would understand the terms “face”, “bead ring”, “simulated bead ring” and “drop center” with respect to an automobile wheel (e.g. wheel 100).

Water may accumulate within the channel 106 and must be diverted in order to prevent the accumulation from reaching enough mass to disrupt the balance of the wheel. During vehicle operation, minor imbalances can cause severe disturbances that can lead to loss of control of the vehicle. The bead ring 104 may comprise one or more bolts 110.

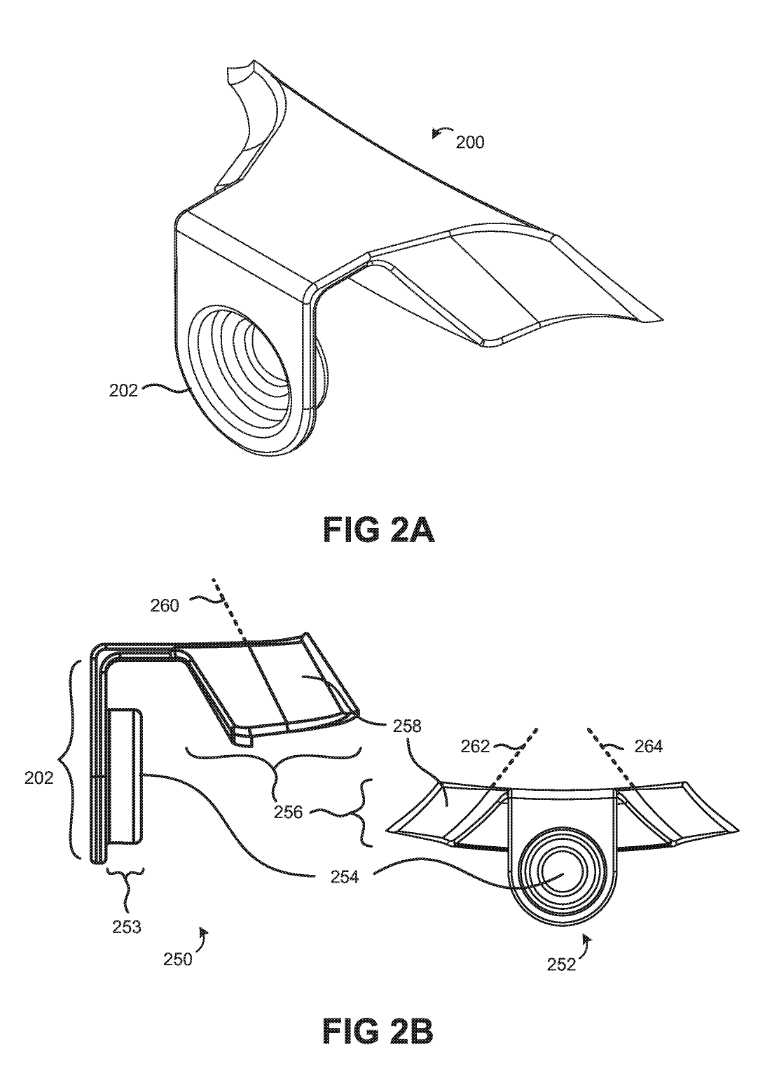

Reference is now made to FIG. 2A, which is a perspective view of a water diverter 200. The water diverter 200 may be structurally configured to fit within the channel 106. During vehicle operation, the water diverter 200 may prevent accumulation of water or other fluid in the channel 106.

Reference is now made to FIG. 2B which shows a side view 250 and a front view 252 of the water diverter 200, according to one or more embodiments. The water diverter 200 may comprise a mounting socket 254 and a diverter arm 256. In one embodiment, the socket 254 may be at the terminus of a cylindrical depression 253 extruded from the adapter 202. The socket 254 may allow mounting of the water diverter 200 to an object. For example, a bolt of the one or more bolts 110 may extend through the socket 254 and fasten to the bead ring 104.

In one embodiment, the diverter arm 256 may be structurally configured to divert a flow of water around the diverter arm 256. Specifically, the diverter arm 256 may be curved in such a way as to direct the flow of water away from the flow trajectory. The diverter arm 256 may comprise one or more ramps 258. As shown in the side view 250, the one or more ramps 258 may be inclined at an angle 260 in the direction of the adapter 202. As shown in the front view 252, the one or more ramps 258 may be inclined towards the midline of the diverter arm 256.

In one embodiment, the diverter arm 256 may comprise two ramps, one on either side of the diverter arm 256 such that when the water diverter 200 is placed within the channel 106, the two ramps lie flush against the channel 106. One of the ramps may be inclined at an angle 262 towards the midline of the diverter arm 256. The other ramp may be inclined at an angle 264 towards the midline of the diverter arm 256.

The diverter arm 256 may comprise a curved bottom edge. The curved bottom edge may allow the water diverter 200 to fit snugly into the channel 106. Any size of the diverter arm 256, any number of the one or more ramps 258, or any direction of the angle 260, the angle 262, and the angle 264 may be used to divert some or all of the water from the flow of water. For example, a diverter arm 256 may direct water from a flow of water in the direction of angle 260, which may be pre-determine to be suitable for diverting water from the channel 106 efficiently.

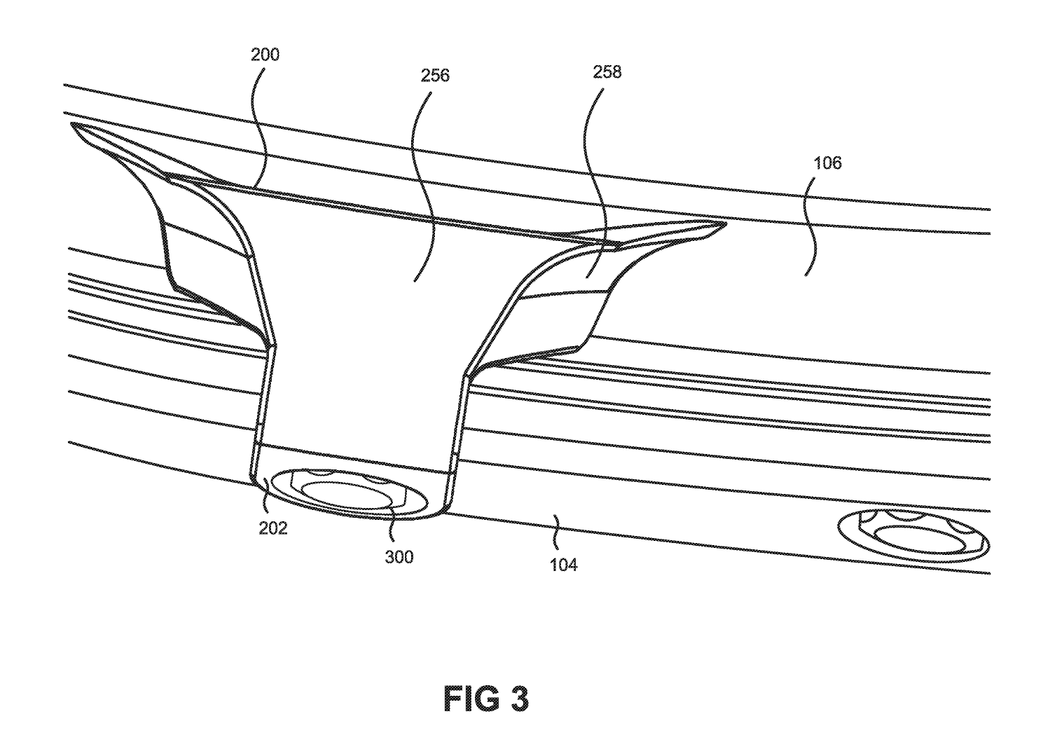

Reference is now made to FIG. 3, which shows a view of the water diverter 200 of FIGS. 2A-B fastened to the bead ring 106 of the wheel 100 of FIG. 1, according to one or more embodiments. The water diverter 200 may be fastened to the wheel 100 by securing it to the bead ring 104 using a bolt 300 of the one or more bolts 110 of the bead ring 104. As shown in FIG. 3, a bolt 300 may be placed through the mounting socket 254, the head of the bolt 300 fitting within the cylindrical depression 253 of the adapter 202.

The diverter arm 256 may rest within the channel 106 of the wheel 100. The one or more ramps 258 of the diverter arm 256 may lie flush against the channel 106. Alternately, the one or more ramps 258 may be designed to be raised from the channel 106. As such, the amount of water removed from the flow of water within the channel may depend on structural configuration of the one or more ramps 258. Since not all wheels are created equal, the channel 106 may be markedly different. For example, the channel 106 may be angled instead of flat. To fit within a channel 106 having an angle of elevation or depression, the one or ramps 258 may be inclined at a wider angle than the angle 260. For example, if the channel 106 is flat, the angle 260 may be orthogonal to the channel 106. It will be understood that angle 260, angle 262, and angle 264 may be any angle and all such angles are within the scope of the embodiments described herein.

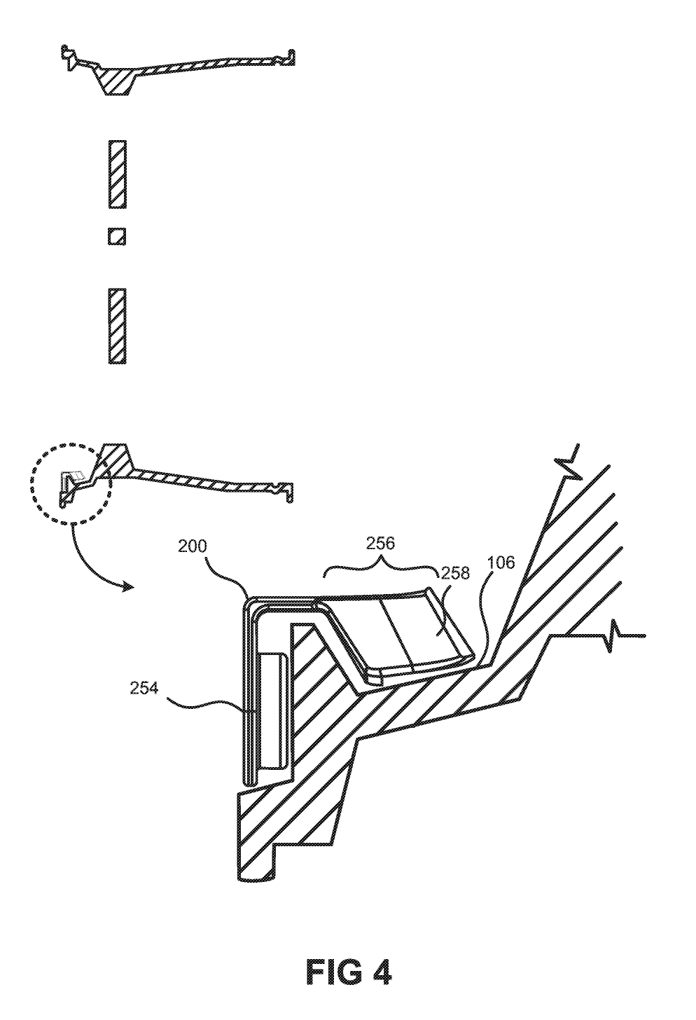

Reference is now made to FIG. 4, which is a sectional view of the wheel 100 of FIG. 1 showing positioning of the water diverter 200 of FIGS. 2A-B within the wheel 100. The structure of the water diverter 200 may be determined based on the form factor of the channel 106. For example, the channel 106 may be angled (as in FIG. 4). Alternately, the channel 106 may be flat or angled differently during machining. Regardless of the angle, the channel 106 may still trap water during operation of the wheel 100. As such, the diverter arm 256 may be particularly structured to fit within the channel 106. Alternately, the diverter arm 256 may be particularly structured to divert only some of the water from the flow of water within the channel 106. As such, the diverter section 256 may not be flush with the channel 106.

Although the present embodiments have been described with reference to specific example embodiments, it will be evident that various modifications and changes may be made to these embodiments without departing from the broader spirit and scope of the various embodiments.

The structures in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A device for attachment to an automobile wheel comprising:
an adapter having a cylindrical depression, the cylindrical depression comprising a socket for securing the device to an automobile wheel; and
a diverter arm coupled to the adapter and extending away from the adapter, the diverter arm extending laterally outward and comprising one or more ramps.

2. The device of claim 1, wherein the adapter is bolted into a bead ring of the automobile wheel.

3. The device of claim 2, wherein the one or more ramps of the diverter arm are disposed within a channel of the automobile wheel between the bead ring and the face of the automobile wheel.

4. The device of claim 3, wherein a side of the diverter arm facing the channel is curved to allow the ends of the one or more ramps to lie flush against the channel.

5. The device of claim 1, wherein the one or more ramps are inclined away from the face of the automobile wheel.

6. The device of claim 1, the diverter arm comprising:
an originating line proximal to the adapter;
a side distal to the adapter,
wherein the distal side is wider than the proximal originating line.

7. The device of claim 2, wherein the bead ring is a simulated bead ring.

8. A device for attachment to an automobile wheel comprising:
an adapter having a cylindrical depression, the cylindrical depression comprising a socket for securing the device to a bead ring of an automobile wheel;
a diverter arm orthogonally positioned to the adapter and coupled to the adapter, the diverter arm comprising one or more ramps, the ends of the one or more ramps configured to lie flush against a channel between the bead ring and the face of the automobile wheel.

9. The device of claim 8, wherein the adapter is bolted into the bead ring of the automobile wheel.

10. The device of claim 9, wherein the diverter arm is disposed within a channel of the automobile wheel between the bead ring and the face of the automobile wheel.

11. The device of claim 10, wherein a side of the diverter arm facing the channel is curved to allow the one or more ramps to lie flush against the channel.

12. The device of claim 8, wherein the one or more ramps flare out from the midline of the diverter arm.

13. The device of claim 8, the diverter arm further comprising:
an originating line proximal to the adapter;
a side distal to the adapter,
wherein the distal side is wider than the proximal originating line.

14. The device of claim 8, wherein the bead ring is a simulated bead ring.

15. A method of diverting water from an automobile wheel using a water diverter device comprising:
securing an adapter of a water diverter device to a bead ring of an automobile wheel, the adapter having a cylindrical depression, the cylindrical depression having a socket at its terminus,
wherein the water diverter device additionally comprises a diverter arm coupled to the adapter and extending away from the adapter, the diverter arm extending laterally outward comprising one or more ramps.

16. The method of claim 15, wherein the adapter is bolted into the bead ring of the automobile wheel.

17. The method of claim 16, further comprising:
placing the one or more ramps of the diverter arm within a channel of the automobile wheel between the bead ring and the face of the automobile wheel.

18. The method of claim 17, wherein a side of the diverter arm facing the channel is curved to allow the ends of the one or more ramps to lie flush against the channel.

19. The method of claim 15, wherein the diverter arm further comprises:
an originating line proximal to the adapter;
a side distal to the adapter,
wherein the distal side is wider than the proximal originating line.

20. The method of claim 15, wherein the bead ring is a simulated bead ring.
